(19) United States
(12) Patent Application Publication
(10) Pub. No.: US 2007/0008730 A1
(43) Pub. Date: Jan. 11, 2007

(54) Luminaire apparatus associated with decoration or text-image picture

(75) Inventor: Chi-Sheng Hsieh, Chupei City (TW)

Correspondence Address: HDSL, 4331 STEVENS BATTLE LANE, FAIRFAX, VA, 22033, US

(73) Assignee: Chi-Sheng Hsieh & Yuan-Chang Jao

(21) Appl. No.: 11/175,202

(22) Filed: Jul. 7, 2005

(51) Int. Cl. F21V 19/00

(52) U.S. Cl. 362/382

(57) ABSTRACT

A luminaire apparatus associated with decoration or text-image picture. By a removable frame shell, user can insert or put his favorite three-dimensional decorations or text-image pictures, and see enlarged and colorful three-dimensional decoration or picture via illuminating the decoration and picture by a light source.

### BACKGROUND OF THE INVENTION

1. Field of the Invention

The invention is about a night lamp, and more particularly to a “small” luminaire apparatus associated with decorations or text-image pictures.

2. Description of the Prior Art

Luminaire in market is divided into two categories, commercial luminaire and home luminaire.

Commercial luminaire is applied in business purpose, including housing, bare lamp, and commercial text and image.

Home luminaire is applied in home decoration and lighting, including large desk lamp, wall lamp, ceiling lamp, and small night lamp.

At present, the night lamp has thousands kinds of different type according to international luminaire exhibition held in New York, US and Tokyo, Japan 2003. Wherein the bare lamp is divided into two categories, incandescent lamp and LED(light-emitting diode) lamp, and the incandescent lamp is going to be replaced by LED lamp in EU countries due to its high temperature when lighting up.

In 2004, popular night lamp in western countries and Japan is mostly made with LED lamp inside as lighting lamp with fixed housing models in printed or pasted, animal or plant appearance. Users can only pick up what they like from those finished products, and hardly to find a luminaire that they can reform with favor image, picture or etc. to perform personality by three-dimensional appearance.

The specification of China Patent NO. ZL03274774.8 “Wall light with liquid decoration” discloses “a sealed cavity in a hollow lampshade contains a liquid or a plurality of liquids with different specific gravity, color, and exclusiveness in can”, “the sealed cavity contains floater or element inside”, “the liquid comprises oil and water”. But the specification is not fully disclosed related information and technology and may cause danger when applying the technology.

Wherein, the oil and water is no clarified in descriptions of “a sealed cavity in a hollow lampshade contains a liquid or a plurality of liquids with different specific gravity, color, and exclusiveness in can” and “the liquid comprises oil and water”.

If the liquid has low ignition point, the high temperature may cause fire or accident. How to put exclusive liquids in can in a sealed cavity? Would the liquid be hazardous to human when the luminaire broken?

Thus, how to improve the variation and keep safety and mass production of small night lamp are desired in the industry. The inventor then invents a proper solution to provide a improved technology.

### SUMMARY OF THE INVENTION

The invention is to provide users a function of reforming with favor text, image, picture or etc. The invention provides a design of removable frame shell, wherein the shell is with a crenellation to form a fillister, and the user can put or insert favor text or image picture in the fillister.

The invention is to provide users a function of performing personality by three-dimensional appearance. The invention provides a design of removable frame shell, wherein the shell is with an internal space, and the users can put favor three-dimensional decoration in it.

The invention is to provide users a function of colorful three-dimensional effects of inserted dynamic or static three-dimensional decoration by the reflection and transmission of lamplight. To achieve the colorful three-dimensional effects, the invention provides a design of removable frame shell. By independently putting the three-dimensional decoration in the removable frame shell and filling a transparent luminaire with ozocerite, a transparent liquid, it can presents an effect of as if putting the three-dimensional decoration in a transparent luminaire, and with enlarging effect when the users watch from the direction of transparent luminaire to the removable frame shell. If the transparent is illuminated by colorful light, it will presents colorful three-dimensional effects.

The invention is to provide a electrical safe design of luminaire. To prevent the wire or driving motor from short circuit due to liquid conduction, the invention provides a removable frame shell to separate the three-dimensional decoration from ozocerite.

Therefore, the invention is invented with novel technology for improving prior art of night lamp lacking of lighting variation and entertaining.

### BRIEF DESCRIPTION OF THE DRAWINGS

The drawings disclose an illustratic embodiment of the present invention which serves to exemplify the various advantages and objects hereof, and are as follows:

FIG. 1 is a perspectively side view of structure of the invention;

FIG. 1A is another perspectively side view of structure of the invention;

FIG. 2 is a side cutaway view of the bare lamp of the invention;

FIG. 2A is a perspectively inserting view of the invention;

FIG. 3 is a perspectively side view of one embodiment of the invention;

FIG. 4 is a perspectively side view of another embodiment of the invention;

FIG. 5 is a perspectively side view of another embodiment of the invention;

FIG. 6 is a perspectively side view of another embodiment of the invention;

FIG. 7 is a perspectively side view of another embodiment of the invention;

FIG. 8 is a perspectively side view of another embodiment of the invention;

FIG. 9 is a perspectively three-dimensional view of another embodiment of the invention; and

FIG. 10 is a perspectively side view of another embodiment of the invention.

### DETAILED DESCRIPTION OF THE PREFERRED EMBODIMENT

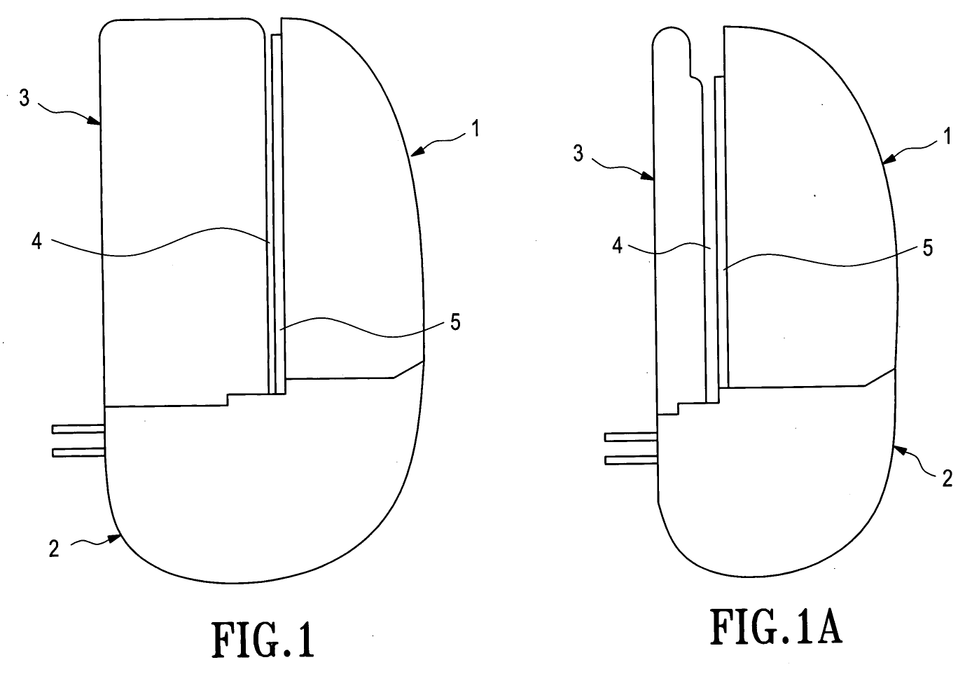

Referring to FIG. 1, one embodiment of the invention, wherein the invention comprises a transparent luminaire 1, a light source 2, a removable frame shell 3, a fillister 4, and a spline notch 5.

FIG. 1A is another embodiment of the invention, which comprises a transparent luminaire 1, a light source 2, a removable frame shell 3, fillister 4, and a spline notch 5. The difference is the enlarged transparent 1 and shrunk removable frame shell 3 in FIG. 1A.

Wherein the purpose of shrinking the removable frame shell 3 is to make the fillister 4 able to be putted or inserted in users' favor text-image pictures.

And, the purpose of enlarging the removable frame shell 3 is to make the internal space of the removable frame shell 3 large enough for favor three-dimensional decorations.

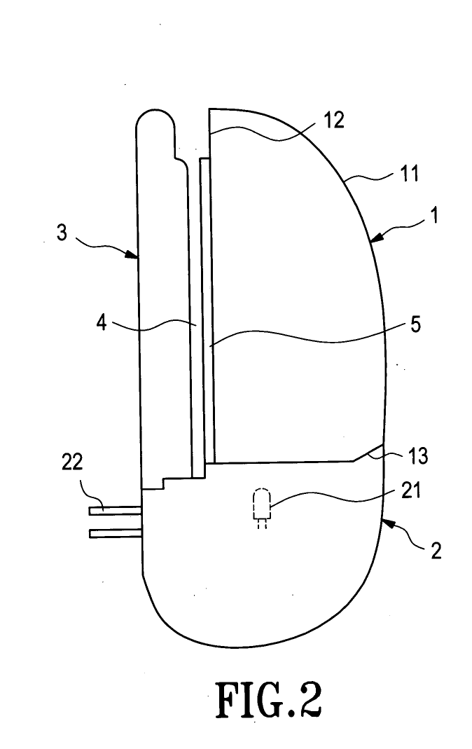

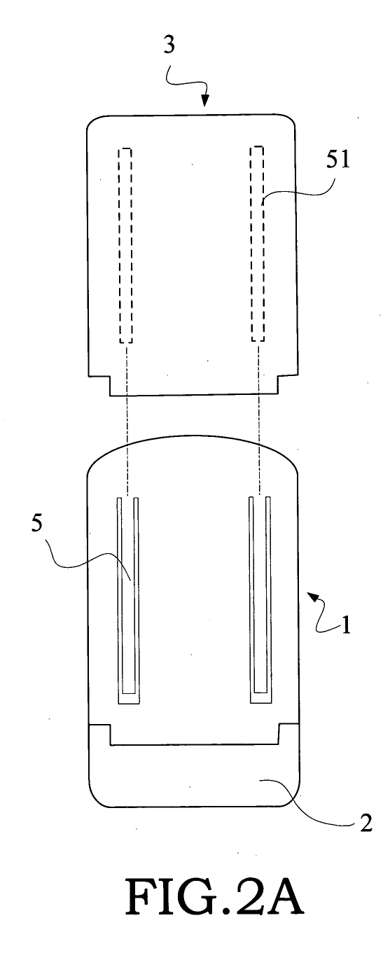

Referring to FIG. 2, wherein the transparent luminaire 1 can be made with transparent acrylic materials, and the transparent luminaire 1 can be hollow inside, able to be filled with liquid, or able to put small decoration, or magnifier in it.

The shape of the invention is similar to a half ellipsoid. The frontage of the transparent luminaire 1 is a half-elliptical surface 11. The rear side 12 of the transparent luminaire 1 is also half-elliptical. Both sides of the rear side 12 have a spline notch 5, and both sides of the removable frame shell 3 have a bolt 51, which make the removable frame shell 3 and the transparent luminaire 1 able to joint, as shown in FIG. 2A. The bottom 13 of the transparent luminaire 1 is slightly like a lens to be contributory for the illuminating from the light source 2 in the bottom 13 to the transparent luminaire 1.

The light source 2 is a case associated with the transparent luminaire 1 in shape, which comprises a plurality of LEDs as the bare lamp, a plug 22 for connecting to power supply to provide power to the light source 2 and the bare lamp 21.

The fillister 4 is a concave plank with a crenellation, the depth of is able to put in suitable text-image picture, printed paper, soft circuitry board, electro luminescent (EL) plate, and other thin slice materials.

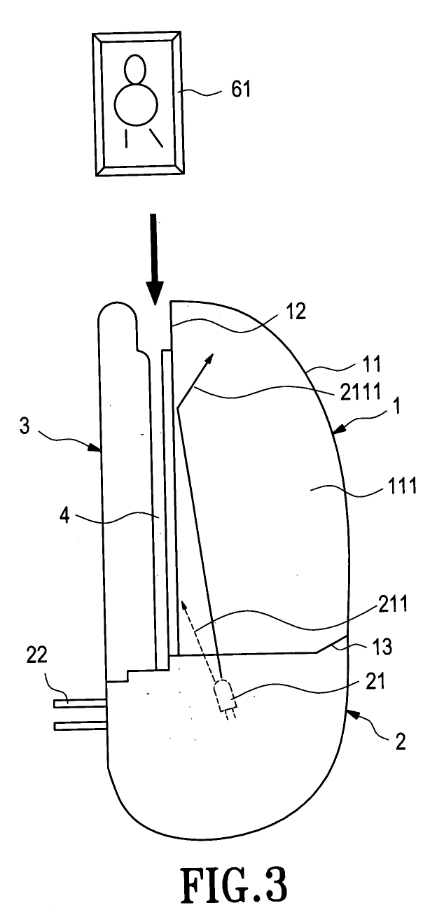

Referring to FIG. 3, the internal space of transparent luminaire 1 can be filled with transparent liquid 111, such as water or ozocerite. The rear side 12 of the transparent luminaire 1 is able to joint with the removable frame shell 3, and the fillister 4 can be inserted with favor text-image picture 61.

By setting the bottom 13 of the transparent luminaire 1 on the light source 2, emitting light 211 from the bare lamp 21 can enter the rear side 12 of the transparent luminaire 1 to illuminate and present the text-image picture 61 in the fillister 4. The users watching from surface of the transparent luminaire 1 can see enlarged text-image picture due to the transparent liquid 111, as a magnifier, in the transparent luminaire 1.

And the emitting light 211, and refracting light 2111 can achieve function of the bare light 21 through the enlarging effect of the transparent liquid 111. When the users insert their favor text-image picture, the night lamp can become a product with personality and uniqueness.

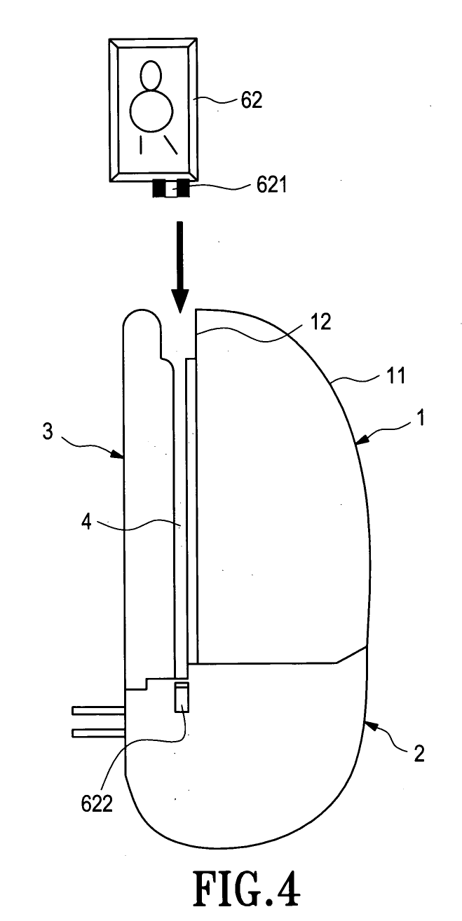

Referring to FIG. 4, the user can put a printed wire picture 62 with a multi-wire slice 621 in the fillister 4 of the removable frame shell 3 of the rear side 12 of the transparent luminaire 1. There are a plurality of EL slices with printed circuit, and a control circuit can control the EL slices to light up in sequence or in the meantime to illuminate the printed wire picture 62 via the multi-wire slices 621.

The inserted picture can be stuck with different color EL slices to have colorful illuminated picture, but it adds cost of manufacturing time and cost of choosing EL slices.

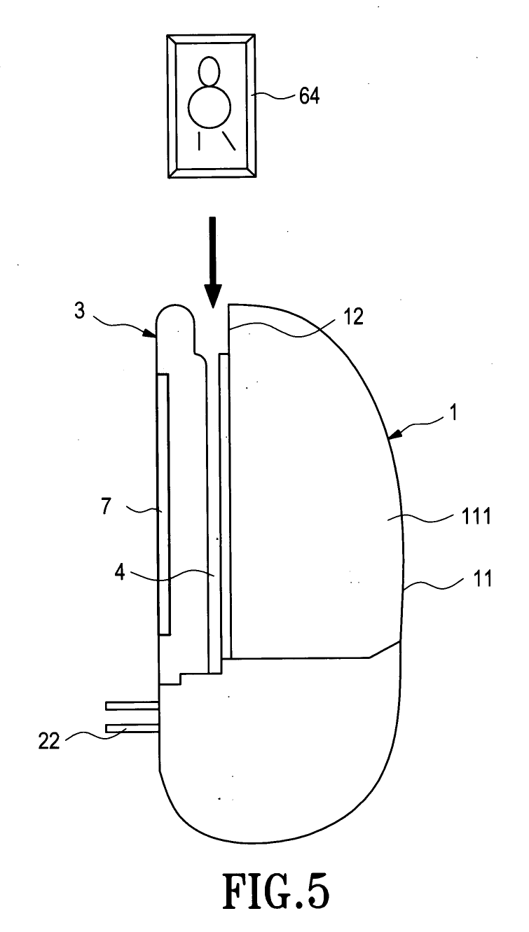

FIG. 5 is another embodiment able to reduce the cost of manufacturing time and choosing EL slices.

First, inserting the EL slice 7 in the removable frame shell 3, and powered the EL slice 7 by the plug 22 of the light source 2. The power supply can by applied to a single EL slice 7 or a plurality of EL slices 7.

Then inserting the picture 64 in the fillister 4, if the picture 64 is not pervious to the emitting light of the EL slice 7, the EL slice 7 is with no-function. Therefore the picture 64 must be transparent.

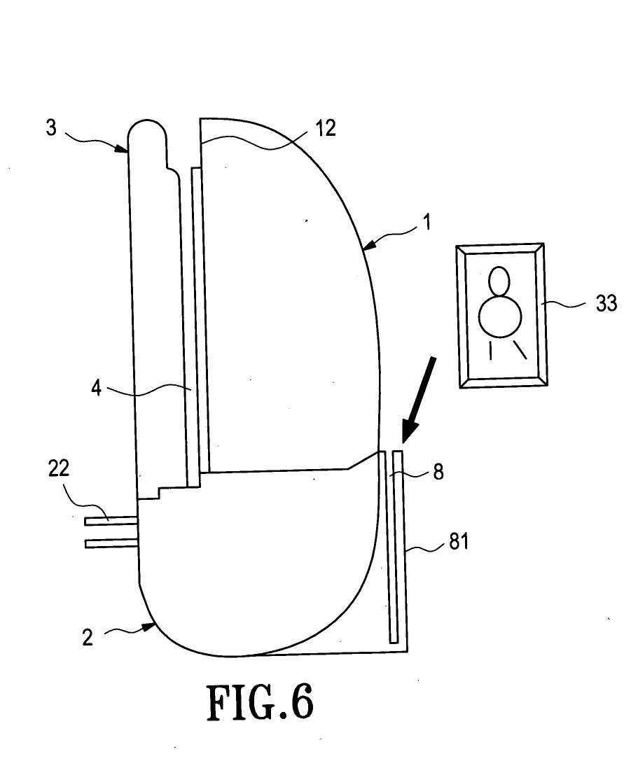

Referring to FIG. 6, if the transparent luminaire 1 is filled with opaque liquid, or the transparent luminaire 1 is filled with transparent liquid but there is a decoration inside the transparent luminaire 1, then the user cannot see the text-image picture inserted in the fillister 4 from the surface 11 of the transparent luminaire 1.

To solve the problem, another embodiment shown in FIG. 6 provides another fillister 8. The fillister 8 is located below the surface 11, id est the opposing position of the plug 22. The user can insert text-image picture 61 in the fillister 8.

To clearly see the text-image picture 61, the text-image picture 61 has to be printed on a transparent material, because the user see the picture by the emitting light from the other side of the picture. And the frontage 81 of the fillister 8 has to be transparent for clearly seeing the picture.

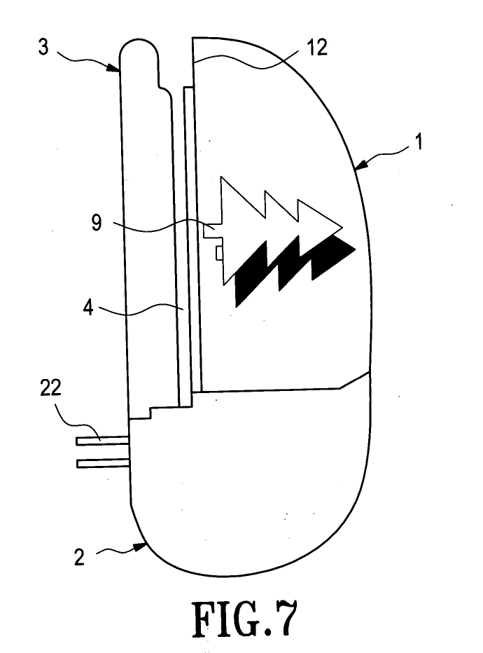

Referring to another embodiment shown in FIG. 7, if the transparent luminaire 1 is filled with transparent liquid 111, and with a decorative element 9 inside, the emitting light from the bottom 13 of the transparent luminaire 1 can make the decorative element 9 reflect the emitting light. More, the user can insert proper back text-image picture in the fillister 4 to enhance the viewing effect and capability of changing background.

When the transparent luminaire 1 is filled with transparent liquid 111 and with a decoration inside, the removable frame shell 3 can be removed from the spline notch 5.

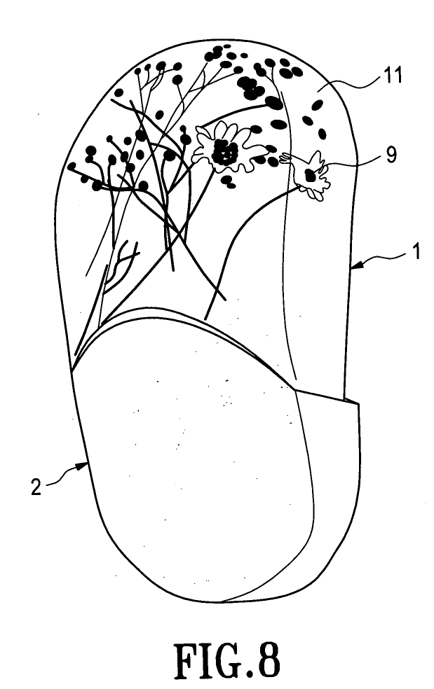

Referring to FIG. 8, the decorative element 9 shown in FIG. 7 can be made as a transparent decorative element 9, and the transparent decorative element 9 can be equipped with other internal light source. When the transparent decorative element 9 is illuminated by the internal light source, the shadow behind the transparent decorative element 9 can be compensated. The shadow is due to the illumination from the bottom 13 of the transparent luminaire 1.

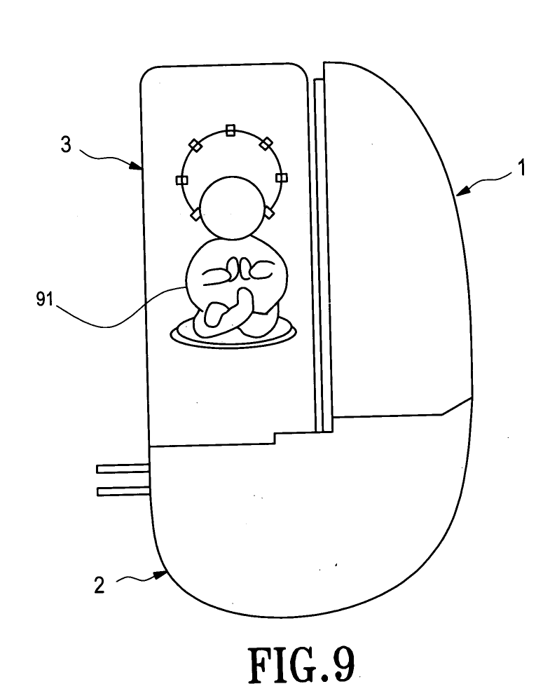

Referring to FIG. 9, the enlarged removable frame shell 3 can be pasted on the transparent luminaire 1 or can be made with the transparent luminaire 1 as a single one element. The internal surface of the removable frame shell 3 can be printed with reflective coating or the removable frame shell 3 can be made with reflective material. And it is able to put a static element 91 inside the removable frame shell 3, the static element 91 can be made as a transparent one. By the previous to light and reflecting effects, it can generate colorful lighting. The static element 91 is not put inside the transparent luminaire 1, as the transparent decorative element 9, but it can be associated with to generate similar effect. The power wire connected to the static element 91 can be directly coupled to the light source 2, to avoid danger may be caused by the wire in liquid.

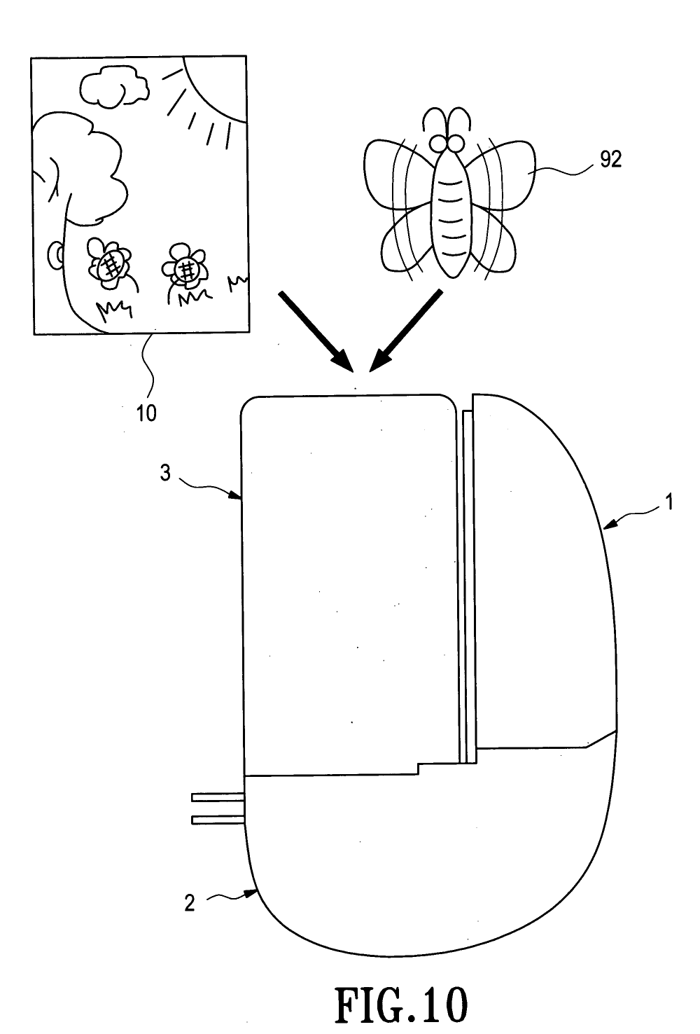

Referring to FIG. 10, a dynamic element 92 can be put in the enlarged removable frame shell 3. The dynamic element 92 can be driven by a driver, such as a small DC motor, to perform dynamic motion. More, the dynamic element 92 and the driver are put in the removable frame shell 3 without filling liquid, therefore the dynamic element 92 and the driver will not have short circuit, rust, and other effects due to the liquid. More the user can draw or paste proper background 10 on the surface of the removable frame shell, to perform a illusion of as if the dynamic element moving in the liquid and to perform variation and entertaining of the night lamp.

The liquid 111 mentioned in the description is a highly safe ozocerite in chemistry. Which is composed of a solid paraffin and a liquid oil, and with high ignition point, low fluid speed, and high transparency.

The method of filling liquid in the transparent luminaire 1 comprises steps of.

Producing a pair of proper size parts of the transparent luminaire 1 with PMMA, a kind of acrylic material, according to a mold;

Cleaning the two parts of the transparent luminaire 1 to avoid unnecessary chemical reaction and keep transparency;

Putting the decoration element 9 in between the two parts of the transparent luminaire 1; and

Integrating the two parts of transparent luminaire 1 by ultrasonic waves to form a close transparent luminaire 1.

Wherein a hole is formed on one part of the transparent luminaire 1 for filling liquid.

Filling liquid one by one costs much. To achieve mass production, manufacturer can put several transparent luminaries 1 with decoration element 9 inside together in a vacuum room; extract air in the vacuum room to make a negative air pressure; put the liquid 111 into the vacuum room. Then the liquid 111 will fill each transparent luminaire 1 via the hold on the transparent luminaire 1. After balancing the air pressure in the vacuum room, retrieving the rest of liquid 111, taking those transparent luminaries 1 out, blocking the hold on the transparent luminaire 1 then cleaning the transparent luminaire 1.

Many changes and modifications in the above described embodiment of the invention can, of course, be carried without departing from the scope there of Accordingly, to promote the progress in science and the useful arts, the invention is disclosed and is intended to be limited only by the scope of the appended claims.

What is claimed is:

1. A luminaire apparatus associated with decorations or text-image pictures comprising a transparent luminaire; a removable frame shell; and a light source,
the transparent luminaire is three-dimensional and hollow for receiving other elements that can be put in the transparent luminaire,
the removable frame shell is able to mount on or separate from the rear side of the transparent luminaire,
the light source is able to illuminate after connected to a power supply, wherein a direction of emitting light is toward a decorative element in the removable frame shell, a text-image picture, or the transparent luminaire,
wherein at least one side of the transparent luminating is pressed close to the light source to make the illuminating light of the light source able to illuminate the transparent luminaire, the decorative element inside the mounted removable frame shell, or the text-image picture in the fillister on the removable frame shell,
the removable frame shell is capable of putting decorative element therein, and
the removable frame shell can mount on or separate from the rear side of the transparent luminaire.

2. The apparatus of claim 1, wherein at least one side of the hollow luminaire is transparent to make inside of the luminaire visible and able to put element in, fill with transparent liquid, or put transparent lens in.

3. The apparatus of claim 1, wherein the decorative element in the hollow luminaire is able to put other light source inside, to make the decorative element another light source.

4. The apparatus of claim 1, wherein the removable frame shell contains a space inside for user to put favor decorative element, and the removable frame shell can be removed when user decides not to use it.

5. The apparatus of claim 1, wherein a fillister is formed between the removable frame shell and the rear side of the transparent luminaire to make user able to insert thin slices of paper, element, or text-image picture.

6. The apparatus of claim 1, wherein the removable frame shell can be pasted on the transparent luminaire or be made with the transparent luminaire as a single one element.

7. The apparatus of claim 1, wherein the surface of the removable frame shell can be printed with reflective coating or the removable frame shell 3 can be made with reflective material to enhance reflecting effect.

8. The apparatus of claim 1, wherein the light source is an illuminating light source comprising a plurality of LEDs or EL slices to illuminate white light or colorful light.

9. The apparatus of claim 1, wherein the power supply of the light source can by supplied by a plug on one side of the light source, or by an internal battery inside the light source.
